(19) United States
(12) Patent Application Publication
(10) Pub. No.: US 2007/0086084 A1
(43) Pub. Date: Apr. 19, 2007

(54) Optical device

(76) Inventors: Toshihiro Mori, Osaka-shi (JP); Shinichi Tsukuda, Osaka-shi (JP); Toshiya Higashi, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/486,134

(22) Filed: Jul. 14, 2006

(30) Foreign Application Priority Data
Oct. 13, 2005 (JP) 2005-299095

(51) Int. Cl. G02B 23/24

(52) U.S. Cl. 359/362

(57) ABSTRACT

Provided is an optical device capable of detecting a breakage of a housing that accommodates an optical system at an early stage and with reliability. The optical device includes a housing having an optical window which is optically transparent and an optical system that is accommodated in the housing and projects/receives light through the optical window, and has a construction in which a electrically conducting region is provided to the optical window of the housing and a breakage of the optical window is detected based on an electric change of the current-carrying region.

### BACKGROUND OF THE INVENTION

1. Field of the invention

The present invention relates to optical devices in which an optical system for projecting light, receiving light, or projecting/receiving light is accommodated in a light transmittable housing.

2. Description of the Related Art

As is well known, optical devices having a construction in which an optical system for projecting light, receiving light, or projecting/receiving light is accommodated in a light transmittable housing, are widely used as sensors which are mounted on automated guided vehicles (AGVs) and detect obstacles or the like existing in traveling region of the AGVs, a surveillance camera installed outdoors, or the like.

An example of this type of optical devices is disclosed in JP 2005-55226 A. The optical device includes a housing having an optical window. Provided within the housing are a light projection optical system for projecting light from the inside of the housing to the outside of the housing through the optical window and a light reception optical system for receiving light introduced from the outside of the housing into the inside of the housing through the optical window. In more detail, the light projection optical system includes a light projection part that emits light and a light projection mirror that reflects the light emitted from the light projection part while making rotation. On the other hand, the light reception optical system includes a light reception mirror that makes rotation in synchronization with the light projection mirror and a light reception part that receives light reflected by the light reception mirror.

Incidentally, as in the optical device disclosed in JP 2005-55226 A, when light is projected, received, or projected and received through an optical window of a housing, the optical window of the housing is made of a transparent material that transmits the light. In addition, as disclosed in JP 2005-55226 A, there is also a case where the entire housing is integrally formed by using the same kinds of the transparent material with the optical window. As such the kinds of the transparent material, for example, polycarbonate, ABS resin, glass, and the like, which have low strength against cracking damages compared with metal materials, are generally used. Therefore, the housing sometime causes the damages when a mechanical shock is applied to the housing including the optical window.

In this type of optical devices, when a housing that accommodates an optical system is broken, a situation may occur in which foreign matter, such as a fragment of the broken housing or dust outside the housing, enters into the housing through a broken portion of the housing. In such a situation, when no countermeasure is taken, there occurs a problem in that the optical system in the housing becomes abnormal due to the foreign matter entering into the housing and it becomes impossible to maintain a function of the optical device with stability.

In view of this problem, usually, a housing of an optical device of this type is visually checked for its broken state. With this method, however, there occurs a situation in which even when a housing is broken, the breakage is overlooked, or a situation in which the breakage of the housing is found after an unreasonably long time has passed from occurrence of the breakage of the housing, which means that the method is insufficient to cope with the problem described above.

### SUMMARY OF THE INVENTION

An object of the present invention is to detect a breakage of a housing which accommodates an optical system at an early stage and with reliability.

According to the present invention which has been made in view of solving the above problem, an optical device includes: a housing having a light transmittable region in at least a part thereof; and an optical system accommodated in the housing, for performing one of light projection, light reception, and light projection/reception, and is characterized in that an electrically conducting region is provided to one of a part of the housing and an entirety of the housing, and whether the housing is broken in a region of the housing in which the electrically conducting region is provided, based on an electric change of the electrically conducting region.

With the construction described above, when the housing is broken in the region in which the electrically conducting region is provided, a short circuit, open circuit, or the like occurs in the electrically conducting region due to the breakage of the housing and an electric change occurs in the electrically conducting region. Therefore, by measuring this electric change, it becomes possible to detect the breakage of the housing at an early stage and with reliability. More specifically, for instance, the electric change in the current-carrying region is measured by applying a constant current or voltage to the electrically conducting region and measuring a change of a electric resistance value of the electrically conducting region resulting from the breakage of the housing as a voltage change or a current change.

In this case, it is preferable that the light transmittable region is formed of an optical window, and the electrically conducting region is provided to the optical window.

In the above structure, it is preferable that the electrically conducting region is formed by one of a continuous linear conductive member and a continuous belt-shaped conductive member.

Accordingly, when the housing is broken in the region in which the electrically conducting region is provided, the conductive member can be easily open due to the breakage of the housing. Consequently, it becomes possible to detect an electric change of the electrically conducting region. As a result, it becomes possible to provide the operation and effect described above with more reliability.

In the above structure, the electrically conducting region may be provided to a surface of the housing.

Accordingly, work to provide the electrically conducting region for the housing becomes easy. Therefore, this construction is advantageous in terms of workability when, for instance, the housing includes multiple easy-to-be-broken portions.

In the above structure, the electrically conducting region may be provided in the middle in a thickness direction of the housing.

With this construction, the electrically conducting region is not exposed to the outside of the housing, so the electrically conducting region is sufficiently protected. As a result, it becomes possible to detect whether the housing is broken or not with stability for a long term.

It should be noted that as a method of providing the electrically conducting region for the surface of the housing, for instance, it is possible to use a method with which a conductive film is formed for the surface of the housing as a conductive member, or a method with which the housing is formed integrally with an electric wire as a conductive member so that the electric wire is set up on the surface layer of the housing. In the case of the latter method, a part of the electric wire may be exposed from the surface of the housing. Also, when the electrically conducting region is provided to a surface of the optical window, it is preferable that a film is formed of a transparent and electric conducting material such as ITO, SnO₂, or the like or an insert-molded electric wire is narrowed, thereby suppressing an influence of a conductive member on a spot diameter of the light at the optical window.

Also, as a method of providing the electrically conducting region in the middle in the thickness direction of the housing, for instance, it is possible to use a method with which the housing is formed integrally with an electric wire so that the electric wire is set up in the housing. Alternatively, for instance, it is possible to use a method with which the housing is formed in a two-layered structure and an electric wire or a conductive film is provided between the layers. Note that when the electrically conducting region is provided in the middle in a thickness direction of the optical window, it is preferable that a transparent conductive film is formed or an electric wire is narrowed like in the above description.

In the above structure, electric contact points may be formed at splicing surfaces of the housing and the optical window

With this construction, when the optical window formed separately from the housing is spliced to the housing through bonding or the like, by forming the electric contact points at the splicing surfaces of the housing and the optical window and detecting an electric change of the electric contact points concurrently with or separately from the housing breakage detection, it becomes possible to detect a change of the splicing states of the housing and the optical window. That is, it becomes possible to detect a situation in which a part of the optical window peels off the housing, or the like at an early stage and with reliability by detecting an electric change of the electric contact points formed at the splicing surfaces of the housing and the optical window.

According to the present invention described above, when the housing is broken in the region in which the electrically conducting region is provided, an electric change occurs in the electrically conducting region due to the breakage of the housing. Therefore, by measuring this electric change, it becomes possible to detect the breakage of the housing at an early stage and with reliability. In addition, the breakage of the housing is detected at an early stage, so it is sufficient to replace only the broken housing, that is, it becomes possible to use continuously the optical system accommodated in the broken housing as it is. As a result, the present invention is advantageous also in terms of economy and makes it possible to swiftly restore a function as an optical device with stability.

### BRIEF DESCRIPTION OF THE DRAWINGS

In the accompanying drawings:

FIG. 1 is a schematic vertical cross-sectional view showing an optical device according to an embodiment of the present invention; and

FIG. 2 is a schematic front view showing an optical window of the optical device according to the embodiment.

### DETAILED DESCRIPTION OF THE PREFERRED EMBODIMENTS

An embodiment of the present invention will be described below with reference to the accompanying drawings.

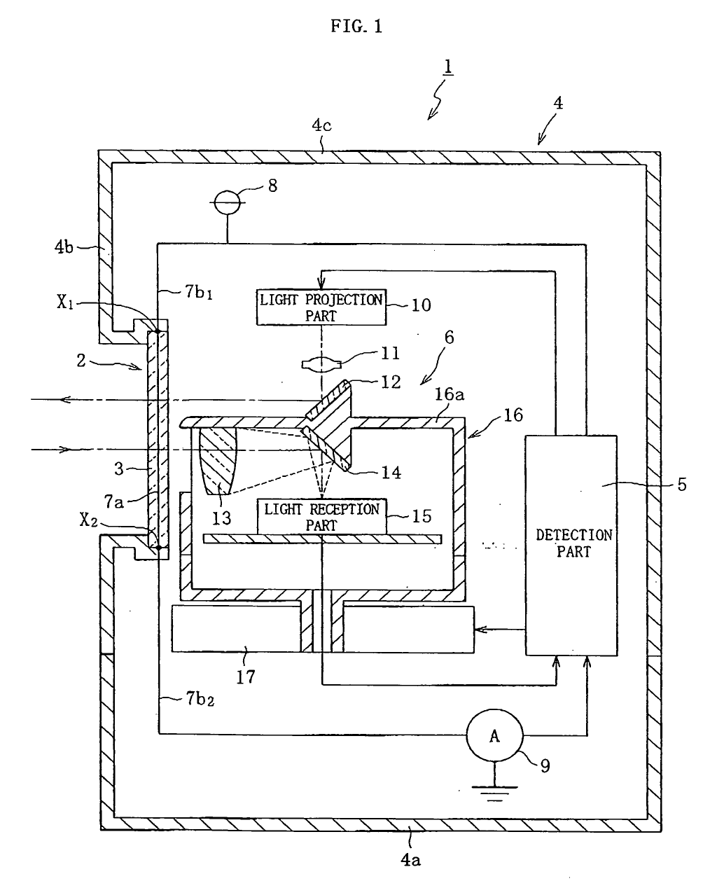

FIG. 1 is a schematic vertical cross-sectional view showing an overall construction of an optical device according to the embodiment of the present invention. As shown in FIG. 1, an optical device 1 has a construction in which in a housing 4 having an optical window 3 provided with an electrically conducting region 2, a detection part 5 that detects a breakage of the optical window 3 based on an electric change of the electrically conducting region 2 and an optical system 6 for projecting/receiving light through the optical window 3 are accommodated.

The housing 4 includes a bottom board 4a, an approximately cylindrical-shaped body portion 4b provided upright around the perimeter of the bottom board 4a, and a top board 4c for closing an upper-end opening of the body portion 4b. The optical window 3 having a horizontally annular shape and a constant width in a vertical direction is fitted to the body portion 4b of the housing 4 and is spliced thereto through bonding This optical window 3 is made of a transparent material such as polycarbonate, an ABS resin, or a glass, and is formed integrally with an electric wire 7 as a conductive member so that the electric wire 7 is set up in a thickness direction of the optical window 3.

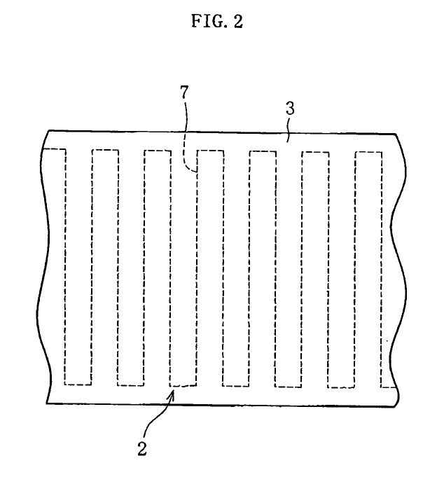

In more detail, as shown in FIG. 2, the electrically conducting region 2 is provided to approximately the entire region of the optical window 3 by forming one line-shaped electric wire 7a for the optical window 3 in a row from one end to the other end in a widthwise direction of the optical window 3 while meandering in a rectangular wave manner (comb manner). Note that the present invention is not limited to the construction in which the electric wire 7a is formed to meander in a rectangular wave manner, and it is sufficient that the electrically conducting region 2 is provided to approximately the entire region of the optical window 3. For instance, a construction may be used instead in which one electric wire 7 is formed in a row in a spiral manner over approximately the entire region of the optical window. Also, the electric wire 7a is not limited to the line shape and may have a belt shape instead

Now, referring again to FIG. 1, the electric wire 7a is drawn out from both ends of the optical window 3 and is connected to electric wires 7b₁, and 7b₂ through electric contact points X₁ and X₂ formed at a part of splicing surfaces of the optical window 3 and the housing 4. Electric wire 7b₁, one of the electric wires 7b₁ and 7b₂, is connected to the detection part 5 through a power source 8 and electric wire 7b₂, the other thereof, is connected to the detection part 5 through an ammeter 9. With this construction, a constant voltage is continuously or intermittently applied from the power source 8 to the electrically conducting region 2 and a value of a current passed through the electrically conducting region 2 at the time of the voltage application is detected by the ammeter 9. This current value detected by the ammeter 9 is input into the detection part 5.

The detection part 5 measures a change of a resistance value of the electrically conducting region 2 that changes due to a breakage (crack) of the optical window 3 as a change of the input current value and detects the breakage of the optical window 3 based on this current value change. More specifically, at the time of shipment or the like of the optical device 1, a current value input into the detection part 5 in a state in which the optical window 3 is not damaged is prestored as a reference current value and a setting is made so that when a current value input into the detection part 5 at the time of the voltage application by the power supply 8 decreases to 50% or less of the reference current value, it is judged that the optical window 3 is broken. Note that even in a state in which a part of the optical window 3 peels off the housing 4 and a gap is generated between the optical window 3 and the housing 4, an attachment position of the optical window 3 with respect to the housing 4 changes due to the gap, so contact status of the electric wire 7a and the electric wires 7b₁, or 7b₂ at the electric contact points X₁ or X₂ formed at the splicing surfaces of the optical window 3 and the housing 4 change. Therefore, the state in which the optical window 3 is peeled off from the housing 4 in part and a gap is generated therebetween also appears as a change of the current value input into the detection part 5. Accordingly, the detection part 5 is also capable of detecting a change of the splicing states of the optical window 3 and the housing 4 based on a change of the inputted current value.

Meanwhile, in this embodiment, the optical system 6 accommodated in the housing 4 includes a light projection optical system including a light projection part 10, an optical lens 11, and a light projection mirror 12 and a light reception optical system including a light reception lens 13, a light reception mirror 14, and a light reception part 15. In more detail, a construction is used in which to upper and lower surfaces of a top board portion 16a of a cap-shaped rotation body 16 that is rotationally driven, the light projection mirror 12 that reflects light emitted from the light projection part 10 toward a measurement target object (not shown) through the optical window 3 and the light reception mirror 14 that reflects the light reflected by the measurement target object and introduced into the housing 4 through the optical window 3 toward the light reception part 15 are respectively attached in an inclined state. Also, to a lower-end portion of the rotation body 16, a rotational drive part 17 that transmits a rotational drive force to the rotation body 16 is coupled. With this construction, the light emitted from the light projection part 10 is scanned into an ambient space along with rotation of the rotation body 16. Here, the detection part 5 also calculates a distance to the measurement target object by comparing the light emitted from the light projection part 10 and the light received by the light reception part 15 with each other.

As described above, with the optical device 1 according to this embodiment, when the optical window 3 provided with the electrically conducting region 2 is broken, an electric change occurs in the electrically conducting region 2 due to the breakage of the optical window 3. Therefore, by measuring this electric change, it becomes possible to detect the breakage of the optical window 3 at an early stage and with reliability. In addition, the breakage of the optical window 3 is detected at an early stage, so it is sufficient to replace only the housing 4, that is, it becomes possible to continuously use the optical system 6 accommodated in the housing 4 as it is. This means that the present invention is advantageous also in terms of economy. In addition, it becomes possible to swiftly restore the function of the optical device 1 with stability, so the present invention is extremely advantageous from a practical standpoint.

It should be noted that the present invention is not limited to the embodiment described above. For instance, in the embodiment described above, a case where the electrically conducting region 2 is formed using the electric wire 7 is described as an example, but a conductive film formed through vapor deposition or the like may be used as the conductive member instead of the electric wire 7. In this case, it becomes possible to provide the electrically conducting region 2 for the surface of the optical window 3 with ease.

Also, in the embodiment described above, the electric wire 7 may be set as a heater electric wire (nichrome wire). In this case, it becomes possible to simultaneously provide an effect of preventing fogging of the optical window 3 in addition to the effect of enabling detection of a breakage of the optical window 3.

Further, in the embodiment described above, a case where the electrically conducting region 2 is provided only for the optical window 3 is described as an example but when the housing 4 includes easy-to-be-broken portions other than the optical window 3 due to materials employed, a use form, or the like, the electrically conducting region 2 may be provided also for the easy-to-be-broken portions other than the optical window 3 and presence or absence of breakage may be detected also in the portions in the same manner as in the case of the optical window 3.

The optical device according to the present invention is suitable as an optical device for use in a sensor that is mounted on automated guided vehicles (AGVs) and detects obstacles or the like existing in a traveling region, a surveillance camera installed outdoors, or the like.

1. An optical device, comprising:
a housing having a light transmittable region in at least a part thereof; and
an optical system accommodated in the housing, for performing one of light projection, light reception, and light projection/reception,
wherein an electrically conducting region is provided to one of a part of the housing and an entirety of the housing, and whether the housing is broken is detected in a region of the housing in which the electrically conducting region is provided, based on an electric change of the electrically conducting region.

2. An optical device according to claim 1, wherein:
the light transmittable region is formed of an optical window; and
the electrically conducting region is provided to the optical window.

3. An optical device according to claim 1, wherein the electrically conducting region is formed by one of a continuous linear conductive member and a continuous belt-shaped conductive member.

4. An optical device according to claim 2, wherein the electrically conducting region is formed by one of a continuous linear conductive member and a continuous belt-shaped conductive member.

5. An optical device according to claim 1, wherein the electrically conducting region is provided to a surface of the housing.

6. An optical device according to claim 2, wherein the electrically conducting region is provided to a surface of the housing.

7. An optical device according to claim 3, wherein the electrically conducting region is provided to a surface of the housing.

8. An optical device according to claim 4, wherein the electrically conducting region is provided to a surface of the housing.

9. An optical device according to claim 1, wherein the electrically conducting region is provided in the middle in a thickness direction of the housing.

10. An optical device according to claim 2, wherein the electrically conducting region is provided in the middle in a thickness direction of the housing.

11. An optical device according to claim 3, wherein the electrically conducting region is provided in the middle in a thickness direction of the housing.

12. An optical device according to claim 4, wherein the electrically conducting region is provided in the middle in a thickness direction of the housing.

13. An optical device according to claim 2, wherein electric contact points are formed at splicing surfaces of the housing and the optical window.
